(19) United States
(12) Patent Application Publication
(10) Pub. No.: US 2024/0326200 A1
(43) Pub. Date: Oct. 3, 2024

(54) SYSTEM AND APPARATUS FOR MODULAR CLAMPING

(71) Applicant: Ian Cory MCPHEE, Spring, TX (US)

(72) Inventor: Ian Cory MCPHEE, Spring, TX (US)

(21) Appl. No.: 18/623,999

(22) Filed: Apr. 1, 2024

Related U.S. Application Data
(60) Provisional application No. 63/493,888, filed on Apr. 3, 2023.

(51) Int. Cl. B25B 5/02

(52) U.S. Cl. CPC B25B 5/02

(57) ABSTRACT

A clamping system includes a flat substrate defining a doghole, and a clamp assembly. The clamp assembly includes a clamp providing a clamp body, the clamp body providing an angled clamp surface defined on a first side of the clamp body and tapering outwardly from a top end of the clamp to a bottom end of the clamp, and a series of retention teeth defined on a second side of the clamp body opposite the first side of the clamp body. The clamp assembly further includes a wedge providing a wedge body, the wedge body providing an angled wedge surface on a first side of the wedge body and tapering inwardly from a top end of the wedge to a bottom end of the wedge, wherein slidingly engaging the clamp and the wedge within the doghole forms an interference fit at the doghole.

### FIELD OF THE DISCLOSURE

The present disclosure relates generally to clamping fasteners and, more particularly, to removable clamps for securing workpieces to a flat substrate.

### BACKGROUND OF THE DISCLOSURE

Woodworking and other applications often require a means of clamping or securing a workpiece to a flat substrate (e.g., a work table), which allows a number of operations to be performed on the workpiece with stability. One common clamping means is an “L-clamp,” which is designed to be inserted into a hole, commonly referred to as a “doghole,” defined in the flat substrate. Once aligned with the doghole, the L-clamp is forced downwards into the doghole and simultaneously into vertical clamping engagement with the workpiece.

L-clamps are often oversized in comparison to the dogholes, which allows them to be forcibly driven into the dogholes and retained via an interference fit. However, this mechanism of insertion can plastically deform the dogholes and otherwise damage the substrate. Further, removing the L-clamp may require applying a large lateral force to the L-clamp, which can further deform or damage the doghole.

Apart from damage to the dogholes, the use of L-clamps may prevent the performance of certain operations on a workpiece. For example, the size and shape of the profile of the L-clamp may overlap vital areas of a workpiece that need to be milled or cut, such as those performed by computerized numerical control (CNC) machines. Using conventional clamping mechanisms in conjunction with CNC machines often results in damage to the clamping mechanism, the CNC machine, the cutting bit, or any combination thereof. Further, modifications may be required in the use of common clamping mechanisms to prevent damage to the substrate during operations, which could include a full vertical cut of the workpiece.

Accordingly, an improved system for clamping, involving one or more novel apparatuses, is desirable for a streamlined and non-damaging clamping process.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a clamping system includes a flat substrate defining a doghole, a clamp assembly including a clamp and a wedge slidingly engageable at a sliding interface when jointly received within the doghole, wherein slidingly engaging the clamp and the wedge within the doghole forms an interference fit at the doghole.

In another embodiment, a clamp assembly includes a clamp providing a clamp body, the clamp body providing an angled clamp surface defined on a first side of the clamp body and tapering outwardly from a top end of the clamp to a bottom end of the clamp, and a series of retention teeth defined on a second side of the clamp body opposite the first side of the clamp body. The clamp assembly further includes a wedge providing a wedge body, the wedge body providing an angled wedge surface on a first side of the wedge body and tapering inwardly from a top end of the wedge to a bottom end of the wedge, wherein the angled wedge surface slidingly engages the angled clamp surface at a sliding interface when the clamp and the wedge are received within a doghole of a flat substrate and thereby form an interference fit with the doghole, and wherein the series of retention teeth engage an interior circumferential surface of the doghole and thereby limit vertical motion of the clamp and the wedge when received within the doghole.

In a further embodiment, a clamping system includes a flat substrate defining a doghole, and a clamp assembly. The clamp assembly includes a clamp providing a clamp body, the clamp body providing an angled clamp surface defined on a first side of the clamp body and tapering outwardly from a top end of the clamp to a bottom end of the clamp, and a series of retention teeth defined on a second side of the clamp body opposite the first side of the clamp body. The clamp assembly further includes a wedge providing a wedge body, the wedge body providing an angled wedge surface on a first side of the wedge body and tapering inwardly from a top end of the wedge to a bottom end of the wedge, wherein slidingly engaging the clamp and the wedge within the doghole forms an interference fit at the doghole.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A is an isometric view of an example clamping system, according to one or more embodiments of the present disclosure.

FIG. 1B is a schematic side view of the example clamping system and substrate, according to one or more embodiments of the present disclosure.

FIG. 2 is a schematic side view of the clamp assembly of FIGS. 1A-1B, according to one or more embodiments of the present disclosure.

FIG. 3A is an isometric view of the lateral clamping device of FIGS. 1A-1B, according to one or more embodiments of the present disclosure.

FIG. 3B is an isometric view of a raised lateral clamping device, according to one or more embodiments of the present disclosure.

FIG. 4A is an isometric view of the securing attachment of FIGS. 1A-1B, according to one or more embodiments of the present disclosure.

FIG. 4B is an isometric view of a tenting attachment for use in the clamp assembly of FIGS. 1A-1B.

FIG. 4C is an isometric view of a vertical spacer for use in the flat substrate of FIGS. 1A-1B.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to clamping fasteners and, more particularly, to removable clamps for securing workpieces to a flat substrate. The embodiments disclosed herein may include systems and assemblies for removably clamping a workpiece to a flat substrate via one or more dogholes of the flat substrate without damaging the flat substrate. Moreover, the embodiments disclosed herein may enable the application of lateral and vertical clamping forces to a workpiece using a variety of modular components. The systems and assemblies of the present disclosure may include a plurality of attachments disposable within the flat substrate, or within the assemblies, to enable securing, raising, or offsetting the workpiece as desired.

The disclosed clamp assembly may form an interference fit within the dogholes of the flat substrate via a progressive sliding engagement of a wedge component against a clamp. The clamp may include a plurality of retention teeth for limiting vertical translation (movement) of the systems and assemblies once and while inserted. However, removal of the wedge component via one or more indentations defined thereon may enable lateral translation of the clamp and retention teeth away from an internal circumferential surface of the doghole, thus enabling removal of the clamp without damaging the doghole and/or the flat substrate.

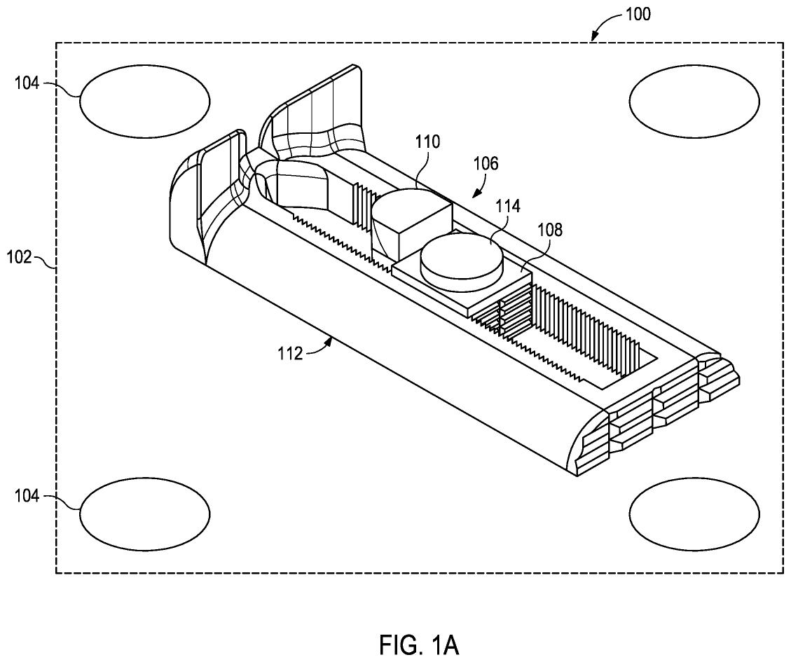

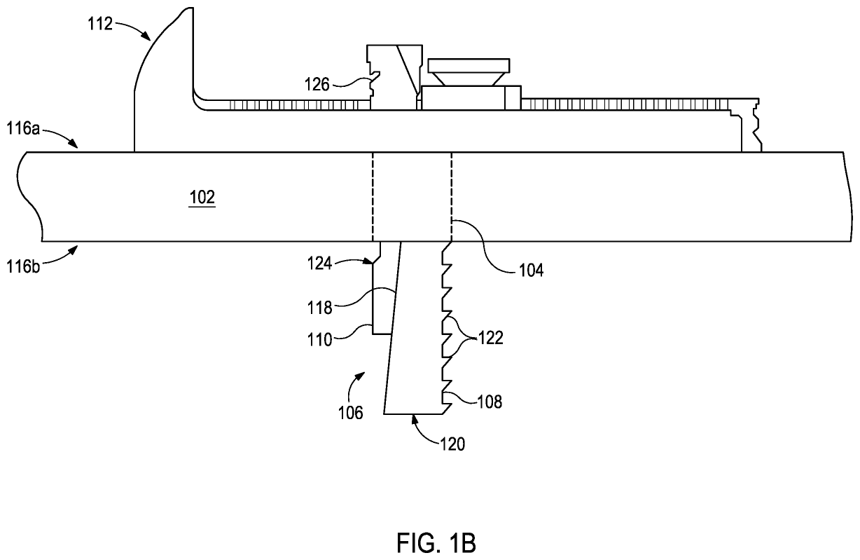

FIG. 1A is an isometric view of an example clamping system 100, according to one or more embodiments of the present disclosure. The clamping system 100 (hereafter “the system 100”) can be used in conjunction with a flat substrate 102 to secure a workpiece (not shown) to the flat substrate 102. As illustrated, the flat substrate 102 may include and otherwise define a series of holes or “dogholes” 104, and the system 100 may be configured to secure the workpiece (or a plurality of workpieces) to the flat substrate 102 using the dogholes 104.

As illustrated, the system 100 may include a clamp assembly 106 that includes at least a clamp 108 and a wedge 110. The clamp 108 and the wedge 110 may comprise complimentary pin-like bodies sized to be cooperatively received within a given doghole 104. Advancing the clamp 108 and the wedge 110 into the doghole 104 generates an interference fit between the clamp assembly 106 and the doghole 104, which can help secure a workpiece to the flat substrate 102, as described herein. In some embodiments, the system 100 may further include a lateral clamping device 112 configured to provide a lateral load on a workpiece. As illustrated, the lateral clamping device 112 may be configured to mate and interact with the clamp assembly 106 to apply a lateral force against the workpiece. More specifically, the lateral clamping device 112 may be mated with the clamp assembly 106 such that the lateral clamping device 112 is able to move laterally in one direction to apply the lateral force against the workpiece, and the clamp assembly 106 prevents the lateral clamping device 112 from reversing in the opposite direction, thus maintaining the lateral force against the workpiece.

In some embodiments, the system 100 may further include a securing or stabilizing attachment 114, which may be coupled to or form an integral part of the clamp assembly 106. As described herein, the securing or stabilizing attachment 114 allows for the mounting of a workpiece atop the clamp assembly 106. Alternative embodiments of the system 100 may include additional tooling or components, which may be mounted in place of the securing or stabilizing attachment 114, as described further herein.

FIG. 1B is a schematic side view of the example clamping system 100 and flat substrate 102, according to one or more embodiments of the present disclosure. In the illustrated embodiment, the clamp assembly 106 is partially inserted (received) within a doghole 104 (shown as dashed lines) and mated to the lateral clamping device 112. As illustrated, the clamp assembly 106 is inserted through the doghole 104 via a top surface 116a of the flat substrate 102, extends through the flat substrate 102, and protrudes from (out) a bottom surface 116b thereof.

To install the clamp assembly 106, the clamp 108 is first fully inserted through the doghole 104 in a desired placement for the clamp assembly 106 and the lateral clamping device 112. To secure the clamp assembly 106 in place at the doghole 104, the wedge 110 may then be inserted through the doghole 104 to form an interference fit against the clamp 108 and the doghole 104. As received within the doghole 104, the wedge 110 slidingly engages the backside of the clamp 108 at a sliding interface 118 therebetween. Sliding engagement at the sliding interface 118 may enable progressive insertion of the wedge 110 to a desired depth, such that the force of the interference fit can be adjusted and tuned accordingly.

As shown in the illustrated embodiment, the clamp 108 may include an elongate clamp body 120 that defines the insertable portion of the clamp 108. The clamp body 120 may further include a plurality of retention teeth 122 defined on a first side of the clamp body 120. The retention teeth 122 help increase a frictional force between the clamp 108 and the doghole 104 when the clamp assembly 106 is fully inserted therein. In some embodiments, the retention teeth 122 can deform and/or penetrate into the flat substrate 102 to further limit motion of the clamp assembly 106 following installation. As illustrated, the retention teeth 122 may be defined with an upwardly-angled trajectory, which facilitates uninterrupted downward insertion into a given doghole 104. Once received within the doghole, however, the retention teeth 112 will dig into the adjacent walls of the doghole 104 and thus resist vertical, upward movement. This helps prevent the clamp assembly 106 from inadvertently reversing out of the doghole 104.

The wedge 110 similarly includes an elongate wedge body 124 that defines an insertable portion (e.g., a portion that is inserted into the doghole 104) that is slidably engageable with an opposing portion of the clamp body 120 when received in the doghole 104. The clamp and wedge bodies 120, 124 can be complementarily-shaped to form the sliding interface 118 between the clamp 108 and wedge 110. As the wedge body 124 is progressively inserted into the doghole 104 and into sliding engagement with the clamp body 120, the functional diameter of the clamp assembly 106 increases within the doghole 104 until an interference fit is generated therein. In some embodiments, the wedge body 124 may further displace the clamp body 120 towards an internal circumferential surface of the doghole 104 to force the retention teeth 122 into and/or towards the flat substrate 102.

The retention teeth 122 may help limit the vertical translation (movement) of the clamp assembly 106 following installation, such that the clamp 108 is not removable without damaging the flat substrate 102. In some embodiments, the wedge body 124 may define a plurality of indentations 126 opposite the sliding interface 118 to enable the insertion of a prying tool (not shown) used to dislodge the clamp assembly 106. More specifically, the indentations 126 provide locations where the prying tool (e.g., the blade of a flat head screwdriver or the like) can be inserted, following which an upward force can be applied to the wedge 110 using the prying tool. The upward force may help slidingly disengage (dislodge) the wedge body 124 from the clamp body 120. Following removal of the wedge body 124, the retention teeth 122 may be laterally unseated from the doghole 104 and the clamp body 120 may then be removed from the doghole 104 without damaging the flat substrate 102.

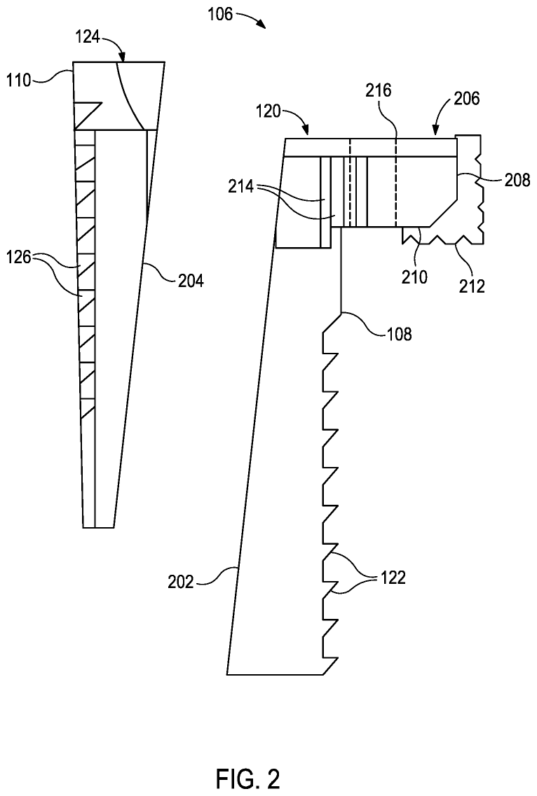

FIG. 2 is a schematic, exploded side view of the clamp assembly 106 of FIGS. 1A-1B, according to one or more embodiments of the present disclosure. As discussed above, the clamp assembly 106 includes the clamp 108 and the wedge 110, which are slidingly engageable to form an interference fit with a doghole 104 (FIGS. 1A-1B). The clamp 108 includes the clamp body 120, which defines an angled clamp surface 202 configured to be slidingly engageable with the wedge 110. The angled clamp surface 202 extends from a top end of the clamp 108 to a bottom end of the clamp 108 and, in some embodiments, tapers outwardly from the top to the bottom.

Similarly, the wedge 110 includes the wedge body 124, which similarly defines a complementary angled wedge surface 204 that may be slidingly engageable with the angled clamp surface 202. The angled wedge surface 204 extends from a top end of the wedge 110 to the bottom end of the wedge 110 and, in some embodiments, tapers inwardly from the top to the bottom. As shown in the illustrated embodiment, the angled clamp surface 202 may be defined on a side of the clamp body 120 opposite the retention teeth 122 of the clamp 108, such that the sliding engagement of the clamp assembly 106 can advance the retention teeth 122 laterally outward and towards the flat substrate 102 of FIGS. 1A-1B. Similarly, the angled wedge surface 204 may be defined on a side of the wedge body 124 opposite the indentations 126, such that an upward force can be applied thereto to slidingly disengage the clamp assembly 106.

The clamp 108 may further include a clamp head 206 integrally formed with the clamp body 120. The clamp head 206 may laterally protrude from the clamp body 120 away from the angled clamp surface 202 and in the same direction as the retention teeth 122. The clamp head 206 can include a front face 208 which can abut a workpiece atop the flat substrate 102 of FIGS. 1A-1B, such that the clamp 108 may laterally retain the workpiece. Further, the clamp head 206 may include a bottom face 210 which may be pressed down towards a workpiece to vertically secure the workpiece to the flat substrate 102 of FIGS. 1A-1B from above.

In some embodiments, the clamp head 206 may further include a clamp grip 212 coupled or otherwise mated to one or both of the front and bottom faces 208, 210. The clamp grip 212 may be configured to provide increased friction against a workpiece when the clamp assembly 106 is installed. In some embodiments, the clamp grip 212 may be made of a rubber or elastomeric material, however, any other friction or grip-generating material, such as knurled metal, sandpaper, a sticky substrate, or the like may be utilized for the clamp grip 212, without departing from the scope of this disclosure. To further increase the friction or gripping capability of the clamp head 206, the clamp grip 212 may include or define a patterned design, which may increase the surface area of the clamp grip 212 exposed to the workpiece as the clamp 108 is installed. By covering the front face 208 and/or the bottom face 210 of the clamp head 206, the clamp grip 212 may enhance gripping or frictional engagement in both lateral and vertical clamping applications.

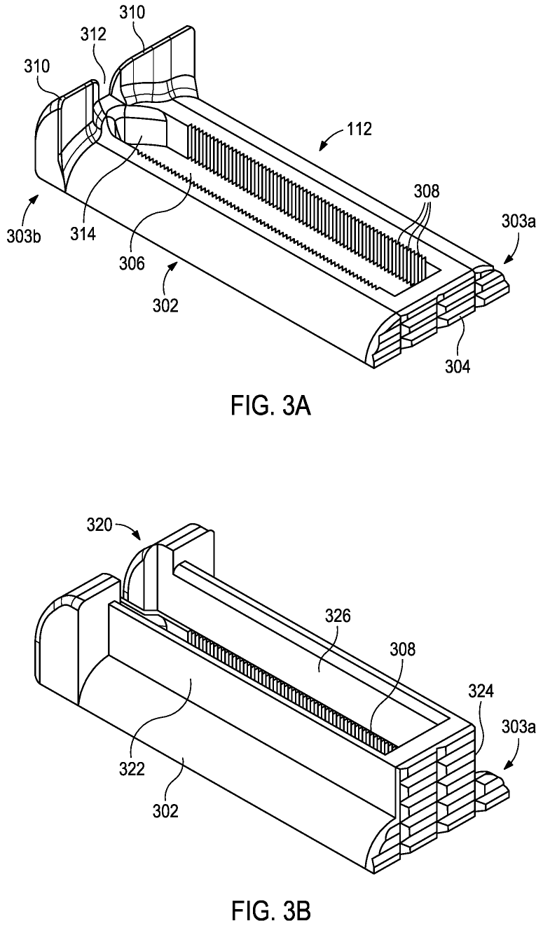

The clamp head 206 may further define a plurality of ratcheting teeth 214 on the side (lateral) faces of the protruding clamp head 206. The ratcheting teeth 214 may be configured to engage and “ratchet” with a corresponding series of ratchet teeth defined within the lateral clamping device 112 of FIGS. 1A-1B (see ratchet teeth 308 of FIG. 3A). Engagement between the opposing ratcheting teeth 214, 308 of the clamp head 206 and the lateral clamping device 112 allows the lateral clamping device 112 to move laterally in one direction, but largely prevent the lateral clamping device 112 from reversing in the opposite direction.

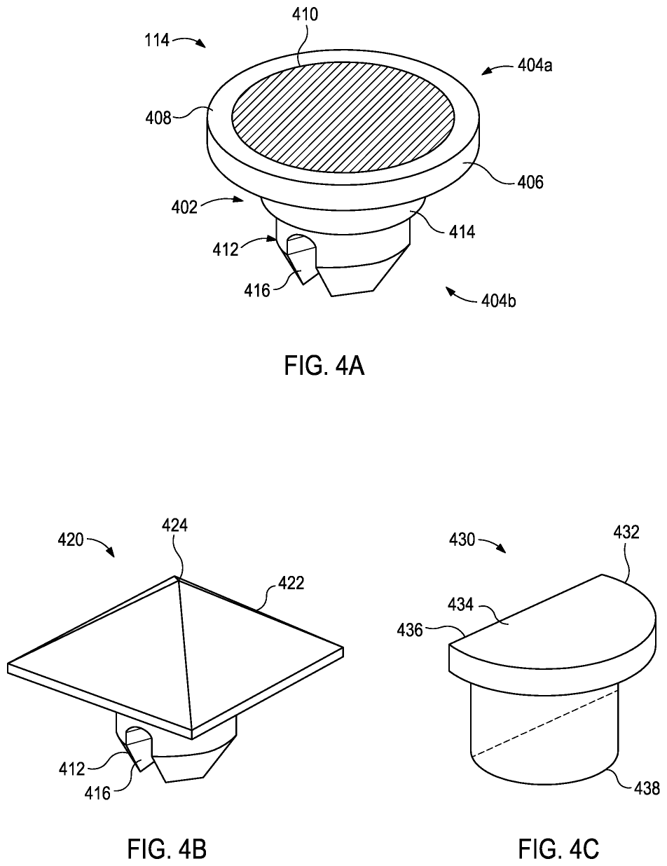

As illustrated, the clamp head 206 may further include or define an attachment orifice 216 (shown in dashed lines), which may facilitate the mating of further components or attachments of the system 100 (FIGS. 1A-1B). More particularly, while the clamp assembly 106 may be used for applying a downward or lateral clamping force on a workpiece, in some embodiments the clamp assembly 106 may be installed independent of a workpiece. In such embodiments, the attachment orifice 216 may provide a location to mount a variety of components or attachments (see FIGS. 4A-4C) that may be used for additional functions while maintaining a stable base provided by the clamp assembly 106.

FIG. 3A is an isometric view of the lateral clamping device 112 of FIGS. 1A-1B, according to one or more embodiments of the present disclosure. The lateral clamping device 112 may include an elongated body 302 having opposing first and second ends 303a and 303b. The body 302 may be matable with the clamp assembly 106 of FIG. 2 and sized based upon a length desired for a particular application. In some embodiments, a lateral grip 304 may be provided at the first end 303a. The lateral grip 304 may aid in laterally stabilizing or clamping a workpiece to the flat substrate 102 (FIGS. 1A-1B). Similar to the clamp grip 212 (FIG. 2), in some embodiments the lateral grip 304 may be made of a rubber or elastomeric material for providing increased friction, however any other friction generating material may be utilized for the lateral grip 304 without departing from the scope of the disclosure. To further increase friction, the lateral grip 304 may include a patterned design (e.g., a series of projections and grooves, etc.), which may increase the surface area of the lateral grip 304 exposed to the workpiece as the lateral clamping device 112 is pressed laterally against a workpiece.

An elongated slot 306 may be defined in the center of the body 302, and a series of ratchet teeth 308 may be defined on the inner walls of the elongated slot 306. The ratchet teeth 308 may be configured to mate with the ratcheting teeth 214 (FIG. 2) provided on the clamp head 206 (FIG. 2). After installing the clamp assembly 106, the lateral clamping device 112 may be installed thereon by receiving the clamp assembly 106 within the elongated slot 306. As the clamp assembly 106 is received within the elongated slot 306, the ratchet teeth 308 may be mated with the ratcheting teeth 214 of the clamp head 206. Ratcheting interaction of the opposing ratcheting teeth 214 and the ratchet teeth 308 enables a user to laterally advance the lateral clamping device 112 into lateral engagement with an adjacent workpiece, while largely prevent the lateral clamping device 112 from reversing direction, thus maintaining a lateral force on the workpiece. The ratcheting teeth 214 of the clamp head 206 may be disengaged from the ratchet teeth 308 following removal of the wedge 110, such that the clamp 108 is free to move and the lateral clamping device 112 may be removed.

In some embodiments, one or more vertical protrusion 310 may be provided or otherwise defined at the second end 303b of the body 302 and opposite to the lateral grip 304. The vertical protrusions 310 may provide a surface upon which a user may manually push or strike the lateral clamping device 112. Striking or pushing the body 302 at the vertical protrusions 310 may help laterally advance the lateral clamping device 112 into lateral engagement with an adjacent workpiece positioned at the first end 303a. Further, the vertical protrusion 310 may provide support for lateral clamping, wherein the workpiece may rest atop the elongated body 302 and be held in place by the vertical protrusions 310. In some embodiments, an intermediate gap 312 may be defined between the vertical protrusions 310. The intermediate gap 312 may provide access to the clamp assembly 106 between the vertical protrusions 310, such that a prying tool may be inserted therethrough to unseat the wedge 110 of FIGS. 1A-2, as generally described above.

In some embodiments, the elongated slot 306 may further include a tapered portion 314 at or near the vertical protrusions 310. The tapered portion 314 may help enable access to the wedge 110 and the indentations 126 thereon when the clamp assembly 106 is inserted at or near the end of the lateral clamping device 112 including the vertical protrusions 310.

FIG. 3B is an isometric view of a raised lateral clamping device 320, according to one or more embodiments of the present disclosure. The raised lateral clamping device 320 may be similar in some respects to the lateral clamping device 112 of FIG. 3A, and therefore may be best understood with reference thereto, where similar reference numerals will correspond to similar components not described again in detail. As illustrated, the raised lateral clamping device 320 includes the elongated body 302. In contrast, however, the raised lateral clamping device 320 may further include a raised body 322 extending vertically from the body 302. The raised body 322 may protect the clamp assembly 106 during machining or manipulation of a workpiece, and may further enable the use of an extended grip 324 provided at the first end 303a of the body 302 and the raised body 322. More specifically, the extended grip 324 may extend vertically along the raised body 322 to increase a vertical profile of the lateral grip 304 of FIG. 3A. The extended grip 324 can enable the application of lateral forces to larger workpieces and can provide further stability as desired.

In contrast to the lateral clamping device 112 of FIG. 3A, the raised body 322 may define a smooth interior surface 326 therein, while the ratchet teeth 308 are defined only within the elongated body 302. In further embodiments, however, the ratchet teeth 308 may extend up into the raised body 322 along some or all of the height of the raised body 322, without departing from the scope of this disclosure.

FIG. 4A is an isometric view of an example of the securing attachment 114 of FIGS. 1A-1B, according to one or more embodiments of the present disclosure. In some embodiments, as illustrated, the securing attachment 114 may provide a generally cylindrical body 402 having a first or “upper” end 404a and a second or “lower” end 404b opposite the upper end 404a. A cylindrical head 406 may be provided or otherwise defined at the upper end 404a, and may generally define a flat surface 408 on a top thereof. In at least one embodiment, a retention patch or pad 410 may be provided on the flat surface 408. In some embodiments, the retention patch 410 may be formed of an adhesive material and may be used to adhere to and secure a workpiece from its underside. In alternative embodiments, the retention patch 410 may be formed of a slip-resistant material, such as rubber or neoprene, to limit or prevent lateral motion and retain the workpiece from its underside. The retention patch 410 may form an integral part of the securing attachment 114, or may be applied to the securing attachment 114 and later removed or replaced.

The lower end 404b of the generally cylindrical body 402 may include or otherwise define an insertion portion 412, and a tapered portion 414 may extend between the cylindrical head 406 and the insertion portion 412. In some embodiments, a deformable slot 416 may be defined in the insertion portion 412 to allow the insertion portion 412 to be elastically deformed to enter a hole, such as the attachment orifice 216 of FIG. 2. Upon removal from the attachment orifice 216, the deformable slot 416 may naturally return (spring) outward. While the securing attachment 114 is shown in FIG. 1A mated with the clamp assembly 106, in some embodiments the securing attachment 114 may be inserted directly into a doghole 104 (FIGS. 1A-1B) to hold a workpiece directly to the flat substrate 102 (FIGS. 1A-1B) from below.

FIG. 4B is an isometric view of a tenting attachment 420 for use in the clamp assembly 106 of FIGS. 1A-1B, or independently within a doghole 104. The tenting attachment 420 may include a pyramidal head 422 protruding vertically away from the tenting attachment 420. A tip 424 may be defined at the center of the pyramidal head 422, and may be a pointed tip as shown or further flattened to a desired shape. The tip 424 may allow for a workpiece to be rested atop the tenting attachment 420, such that only a small surface area is applied to the workpiece, which may be useful in applications such as the drying of paints or stains.

The tenting attachment 420 may further include the insertion portion 412 on an end opposite to the pyramidal head 422. In some embodiments, the insertion portion 412 may include the deformable slot 416, such that the insertion portion 412 may be elastically deformed to enter a hole (e.g., the orifice 216 of FIG. 2) and then naturally return outward as part of a mating process, as with the securing attachment 114 of FIG. 4A. While the tenting attachment 420 may be mated with the clamp assembly 106 (FIGS. 1A-2), in some embodiments the tenting attachment 420 may be inserted directly into a doghole 104 (FIGS. 1A-1B) to support a workpiece directly from below.

FIG. 4C is an isometric view of a vertical spacer 430 for use in the flat substrate 102 of FIGS. 1A-1B. As illustrated, the vertical spacer 430 may include a semi-cylindrical head 432, which defines or provides a flat top surface 434 similar to the flat surface 408 of the securing attachment 114 (FIG. 4A). The semi-cylindrical head 432 may terminate in a flat lateral face 436 which creates a planar portion of the vertical spacer 430. The remainder of the vertical spacer 430 may include a semi-cylindrical body 438, which may be inserted into a doghole 104 (FIGS. 1A-1B) such that a workpiece may be offset from the flat substrate 102 for operations which could damage the flat substrate 102 without the proper spacing.

Embodiments disclosed herein include:

A. A clamping system includes a flat substrate defining a doghole, a clamp assembly including a clamp and a wedge slidingly engageable at a sliding interface when jointly received within the doghole, wherein slidingly engaging the clamp and the wedge within the doghole forms an interference fit at the doghole.

B. A clamp assembly includes a clamp providing a clamp body, the clamp body providing an angled clamp surface defined on a first side of the clamp body and tapering outwardly from a top end of the clamp to a bottom end of the clamp, and a series of retention teeth defined on a second side of the clamp body opposite the first side of the clamp body. The clamp assembly further provides a wedge providing a wedge body, the wedge body providing an angled wedge surface on a first side of the wedge body and tapering inwardly from a top end of the wedge to a bottom end of the wedge, wherein the angled wedge surface slidingly engages the angled clamp surface at a sliding interface when the clamp and the wedge are received within a doghole of a flat substrate and thereby form an interference fit with the doghole, and wherein the series of retention teeth engage an interior circumferential surface of the doghole and thereby limit vertical motion of the clamp and the wedge when received within the doghole.

C. A clamping system includes a flat substrate defining a doghole, and a clamp assembly. The clamp assembly includes a clamp providing a clamp body, the clamp body providing an angled clamp surface defined on a first side of the clamp body and tapering outwardly from a top end of the clamp to a bottom end of the clamp, and a series of retention teeth defined on a second side of the clamp body opposite the first side of the clamp body, and a wedge providing a wedge body, the wedge body providing an angled wedge surface on a first side of the wedge body and tapering inwardly from a top end of the wedge to a bottom end of the wedge, wherein slidingly engaging the clamp and the wedge within the doghole forms an interference fit at the doghole.

Each of embodiments A through C may have one or more of the following additional elements in any combination: Element 1: wherein the clamp includes a clamp body defining an angled clamp surface on a first side and a plurality of retention teeth on a side opposite the angled clamp surface. Element 2: wherein the clamp further includes a clamp head laterally protruding from the clamp body on the side opposite the angled clamp surface. Element 3: wherein the clamp head defines an attachment orifice, the clamping system further comprising one or more attachments including an insertion portion receivable within the attachment orifice. Element 4: wherein the one or more attachments are selected from the group consisting of a securing attachment, a tenting attachment, a spacer, and any combination thereof. Element 5: wherein the one or more attachments comprises a securing attachment that includes: a generally cylindrical body providing a cylindrical head; and a retention patch positioned on a flat top surface of the cylindrical head for engaging a bottom portion of the workpiece. Element 6: wherein the wedge includes a wedge body defining an angled wedge surface complementary to the angled clamp surface on a first side of the wedge body and a plurality of indentations on a side opposite the angled wedge surface. Element 7: further comprising a lateral clamping device including an elongated body defining an elongated slot matable with the clamp assembly when the clamp assembly is received within the doghole, wherein the lateral clamping device is configured to provide a lateral load on an adjacent workpiece when mated to the clamp assembly. Element 8: wherein the clamp provides a clamp body and a clamp head laterally protruding from the clamp body, the clamp head defining a series of ratcheting teeth matable with a plurality of ratchet teeth defined within the elongated slot, wherein mating the series of ratcheting teeth with the plurality of ratchet teeth mates the lateral clamping device with the clamp assembly.

Element 9: wherein elongated body provides opposing first and second ends and the lateral clamping device includes: a lateral grip provided on the first end; and one or more vertical protrusions extending from the elongated body at the second end. Element 10: further comprising a raised body protruding vertically from the elongated body, wherein the raised body provides an extended grip with a surface area greater than the lateral grip. Element 11: wherein the wedge body further defines a series of indentations on a second side of the wedge body opposite the first side of the wedge body, the series of indentations providing a location to apply an upward force to the wedge to disengage the wedge from the clamp. Element 12: wherein the clamp further provides a clamp head protruding laterally from the clamp body at the top end of the clamp to vertically clamp down on a workpiece. Element 13: further comprising a grip secured to the clamp head on a bottom face of the clamp head, a front face of the clamp head, or a combination thereof. Element 14: wherein the clamp head defines an attachment orifice configured to receive and mate with one or more attachments selected from the group consisting of a securing attachment, a tenting attachment, a spacer, and any combination thereof. Element 15: wherein the clamp further provides a clamp head protruding laterally from the clamp body at the top end of the clamp to vertically clamp down on a workpiece interposing the clamp head and the flat substrate. Element 16: further comprising one or more attachments insertable within an attachment orifice defined through the clamp head, the one or more attachments being selected from the group consisting of a securing attachment, a tenting attachment, a spacer, and any combination thereof. Element 17: wherein the doghole comprises a first doghole and the flat substrate defines a second doghole, and wherein the one or more securing attachments are insertable within the second doghole.

By way of non-limiting example, exemplary combinations applicable to A through C include: Element 1 with Element 2; Element 2 with Element 3; Element 3 with Element 4; Element 3 with Element 5; Element 1 with Element 6; Element 7 with Element 8; Element 7 with Element 9; Element 7 with Element 10; Element 12 with Element 13; Element 12 with Element 14; Element 15 with Element 16; and Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A clamping system, comprising:
a flat substrate defining a doghole;
a clamp assembly including a clamp and a wedge slidingly engageable at a sliding interface when jointly received within the doghole,
wherein slidingly engaging the clamp and the wedge within the doghole forms an interference fit at the doghole.

2. The clamping system of claim 1, wherein the clamp includes a clamp body defining an angled clamp surface on a first side and a plurality of retention teeth on a side opposite the angled clamp surface.

3. The clamping system of claim 2, wherein the clamp further includes a clamp head laterally protruding from the clamp body on the side opposite the angled clamp surface.

4. The clamping system of claim 3, wherein the clamp head defines an attachment orifice, the clamping system further comprising one or more attachments including an insertion portion receivable within the attachment orifice.

5. The clamping system of claim 4, wherein the one or more attachments are selected from the group consisting of a securing attachment, a tenting attachment, a spacer, and any combination thereof.

6. The clamping system of claim 4, wherein the one or more attachments comprises a securing attachment that includes:
a generally cylindrical body providing a cylindrical head; and
a retention patch positioned on a flat top surface of the cylindrical head for engaging a bottom portion of the workpiece.

7. The clamping system of claim 2, wherein the wedge includes a wedge body defining an angled wedge surface complementary to the angled clamp surface on a first side of the wedge body and a plurality of indentations on a side opposite the angled wedge surface.

8. The clamping system of claim 1, further comprising a lateral clamping device including an elongated body defining an elongated slot matable with the clamp assembly when the clamp assembly is received within the doghole, wherein the lateral clamping device is configured to provide a lateral load on an adjacent workpiece when mated to the clamp assembly.

9. The clamping system of claim 8, wherein the clamp provides a clamp body and a clamp head laterally protruding from the clamp body, the clamp head defining a series of ratcheting teeth matable with a plurality of ratchet teeth defined within the elongated slot, wherein mating the series of ratcheting teeth with the plurality of ratchet teeth mates the lateral clamping device with the clamp assembly.

10. The clamping system of claim 8, wherein elongated body provides opposing first and second ends and the lateral clamping device includes:
a lateral grip provided on the first end; and
one or more vertical protrusions extending from the elongated body at the second end.

11. The clamping system of claim 8, further comprising a raised body protruding vertically from the elongated body, wherein the raised body provides an extended grip with a surface area greater than the lateral grip.

12. A clamp assembly, comprising:
a clamp providing a clamp body, the clamp body providing:
an angled clamp surface defined on a first side of the clamp body and tapering outwardly from a top end of the clamp to a bottom end of the clamp; and
a series of retention teeth defined on a second side of the clamp body opposite the first side of the clamp body; and
a wedge providing a wedge body, the wedge body providing an angled wedge surface on a first side of the wedge body and tapering inwardly from a top end of the wedge to a bottom end of the wedge,
wherein the angled wedge surface slidingly engages the angled clamp surface at a sliding interface when the clamp and the wedge are received within a doghole of a flat substrate and thereby form an interference fit with the doghole, and
wherein the series of retention teeth engage an interior circumferential surface of the doghole and thereby limit vertical motion of the clamp and the wedge when received within the doghole.

13. The clamp assembly of claim 12, wherein the wedge body further defines a series of indentations on a second side of the wedge body opposite the first side of the wedge body, the series of indentations providing a location to apply an upward force to the wedge to disengage the wedge from the clamp.

14. The clamp assembly of claim 12, wherein the clamp further provides a clamp head protruding laterally from the clamp body at the top end of the clamp to vertically clamp down on a workpiece.

15. The clamp assembly of claim 14, further comprising a grip secured to the clamp head on a bottom face of the clamp head, a front face of the clamp head, or a combination thereof.

16. The clamp assembly of claim 14, wherein the clamp head defines an attachment orifice configured to receive and mate with one or more attachments selected from the group consisting of a securing attachment, a tenting attachment, a spacer, and any combination thereof.

17. A clamping system, comprising:
a flat substrate defining a doghole; and
a clamp assembly including:
a clamp providing a clamp body, the clamp body providing an angled clamp surface defined on a first side of the clamp body and tapering outwardly from a top end of the clamp to a bottom end of the clamp, and a series of retention teeth defined on a second side of the clamp body opposite the first side of the clamp body; and
a wedge providing a wedge body, the wedge body providing an angled wedge surface on a first side of the wedge body and tapering inwardly from a top end of the wedge to a bottom end of the wedge,
wherein slidingly engaging the clamp and the wedge within the doghole forms an interference fit at the doghole.

18. The clamping system of claim 17, wherein the clamp further provides a clamp head protruding laterally from the clamp body at the top end of the clamp to vertically clamp down on a workpiece interposing the clamp head and the flat substrate.

19. The clamping system of claim 18, further comprising one or more attachments insertable within an attachment orifice defined through the clamp head, the one or more attachments being selected from the group consisting of a securing attachment, a tenting attachment, a spacer, and any combination thereof.

20. The clamping system of claim 19, wherein the doghole comprises a first doghole and the flat substrate defines a second doghole, and wherein the one or more securing attachments are insertable within the second doghole.
